(19) United States
(12) Patent Application Publication
(10) Pub. No.: US 2012/0325279 A1
(43) Pub. Date: Dec. 27, 2012

(54) ENVIRONMENTAL CONTAINMENT UNIT

(76) Inventor: JOSE GUADALUPE MUNOZ, Valinda, CA (US)

(21) Appl. No.: 13/531,195

(22) Filed: Jun. 22, 2012

Related U.S. Application Data
(60) Provisional application No. 61/501,134, filed on Jun. 24, 2011.

(51) Int. Cl. E04H 15/14; E04H 15/02; B23P 11/00; E04H 15/34

(52) U.S. Cl. 135/93; 135/121; 135/96; 29/428

(57) ABSTRACT

The present invention relates to environmental containment units, and more particularly to an environmental containment unit with a disposable barrier for use in hospitals, healthcare facilities, clean rooms, and other interiors for creating a controlled localized environment. In one embodiment, an environmental containment unit includes a frame and a disposable barrier supported by the frame. The barrier wraps around a top portion of the frame. The barrier includes a tube and a floor, and the tube may be made of polyethylene film. The barrier is disposable after a single use.

### CROSS-REFERENCE TO RELATED APPLICATIONS

This application claims priority to and the benefit of U.S. Provisional Application No. 61/501,134, filed Jun. 24, 2011, the entire contents of which are expressly incorporated herein by reference.

### FIELD OF THE INVENTION

The present invention relates to environmental containment units, and more particularly to an environmental containment unit with a disposable barrier for use in hospitals, healthcare facilities, clean rooms, and other interiors for creating a controlled localized environment.

### BACKGROUND

Construction and maintenance projects in a hospital provide great potential for releasing contaminants and airborne particulates that can lead to infections or other forms of contamination. All buildings, including hospitals, harbor biological pathogens in the cavities of walls, floors and ceilings. Whenever these cavities are penetrated and the air in them is disturbed, the risk of aerosolizing these pathogens is present. Air currents exist in these cavities, even those that are considered dead air spaces. When an opening is made, the air currents change and pathogens are introduced into the occupied space.

Routine maintenance and repair activities such as opening a ceiling tile or a wall to check, test, or repair equipment, such as for elevator operation, electrical wiring, pneumatic tube systems, plumbing or air conditioning, can release harmful organisms into the environment.

Various containment units have been provided for enclosing a work area and isolating it from a surrounding environment. For example, some units include a frame provided with a barrier made from thick plastic poly-fabric material. The plastic material supported by the frame is effective at shielding the surrounding environment, but it is heavy, takes a long time to install, and is expensive. Multiple attachment points are required to support the weight of the material on the frame, and the resulting structure may be heavy and bulky, reducing its portability. Additionally, the sheeting material is often re-used due to its prohibitive cost. This in turn requires careful and thorough de-contamination and washing of the sheeting material between uses, in order to prevent the spread of contaminants.

As a result, there is still a need for an environmental containment unit that is easy to install, portable, and disposable.

### BRIEF DESCRIPTION OF THE DRAWINGS

FIG. 1 is a perspective view of an environmental containment unit according to an embodiment.

FIG. 2 is a side view of the unit of FIG. 1 after use.

FIGS. 3A-C show side views of the unit of FIG. 1 in various stages of operation.

FIG. 4A is a side view of an environmental containment unit according to an embodiment, including a filter system.

FIG. 4B shows the unit of FIG. 4A configured for storage or transport.

FIG. 4C shows an enlarged view of a portion of the unit of FIG. 4A.

FIG. 4D shows an enlarged view of a portion of the unit of FIG. 4A.

FIG. 5 shows a method for isolating a work area from a surrounding environment, according to an embodiment.

### DETAILED DESCRIPTION

The present invention relates to environmental containment units, and more particularly to an environmental containment unit for use in hospitals, healthcare facilities, clean rooms, and other interiors for creating a controlled localized environment which is isolated from the surrounding environment. The unit is particularly useful in applications involving construction and maintenance in ceiling cavities, wall cavities, and other spaces in which plumbing, wiring, ducting and the like are located.

The environmental containment unit includes an enclosure that separates the working environment inside the enclosure from the surrounding environment outside the enclosure. In one embodiment, the enclosure includes a frame that supports a barrier or envelope. In an exemplary embodiment, the frame is portable and extendable to the desired height depending on the particular application, such as extending up from the floor to the ceiling. The envelope is folded over the top of the frame to secure the envelope to the frame. The envelope acts as a barrier to shield the working environment within the inside surface of the envelope from the external environment. In an embodiment, the frame itself remains external of the envelope, and may be easily moved between locations and re-used, without being exposed to the working environment and potential contaminants. The envelope is made from a lightweight material that is fire-retardant and gas-impermeable and that is disposable after one use. As a result, the barrier material itself does not need to be de-contaminated and cleaned between uses. The environmental containment unit is easy to install and easy to remove.

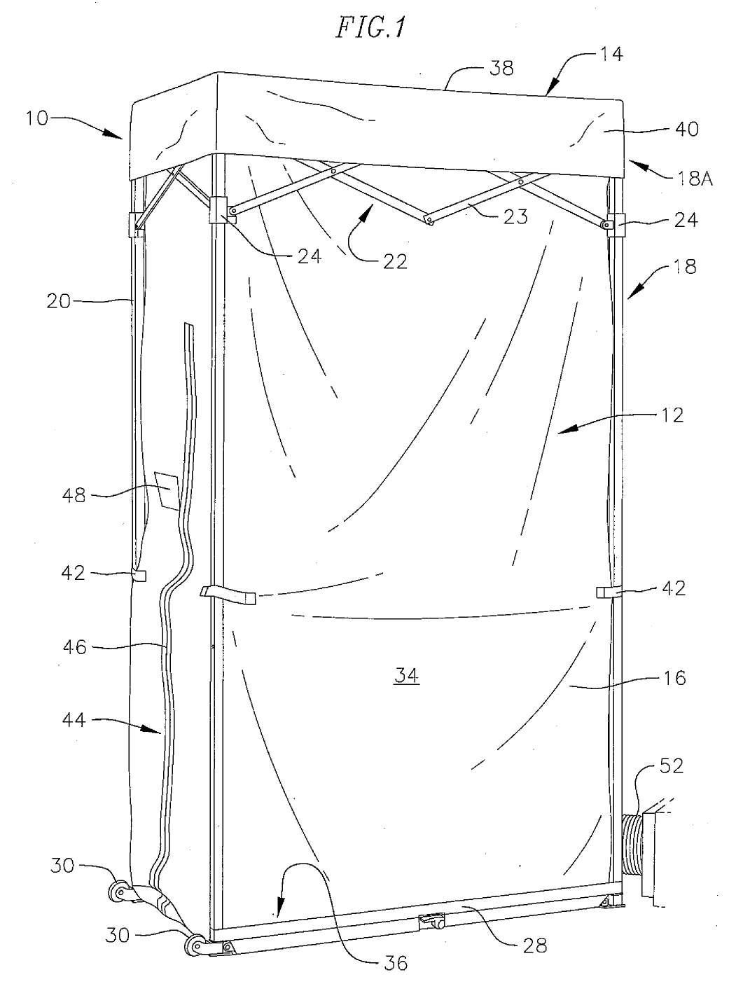

An environmental containment unit 10 according to an embodiment of the invention is shown in FIG. 1. The unit 10 includes an enclosure 12 that defines an inner working space 14. In the embodiment shown, the enclosure is created by a barrier or envelope 16 supported by a frame 18, which in the shown exemplary embodiment is collapsible and extendable. The frame 18 is reusable and can be folded, stored, and transported to other working sites for multiple uses. In another embodiment, the frame is assembled from multiple rigid pieces, and is not collapsible or extendable. In one embodiment, the frame is fixed in a permanently deployed state. The envelope 16 is intended for one-time use and is then disposed, as described in further detail below. The envelope 16 is folded over a top portion of the frame 18 and is secured by two fasteners to each leg of the frame. The small number of attachment points between the envelope and the frame simplifies the installation and removal of the enclosure 12 at the working site.

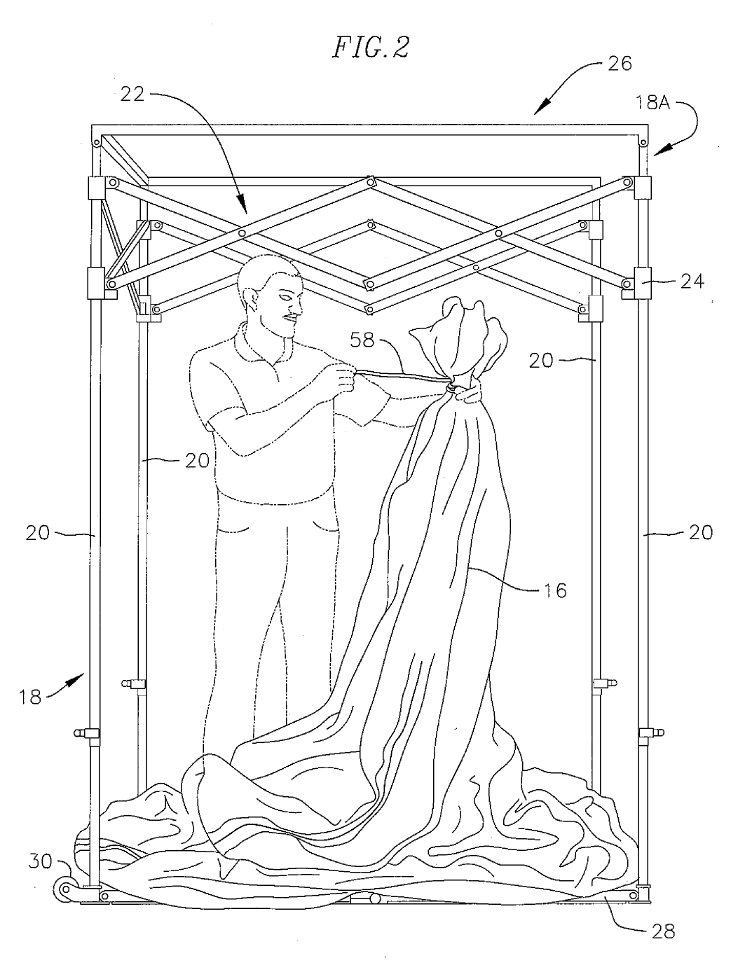

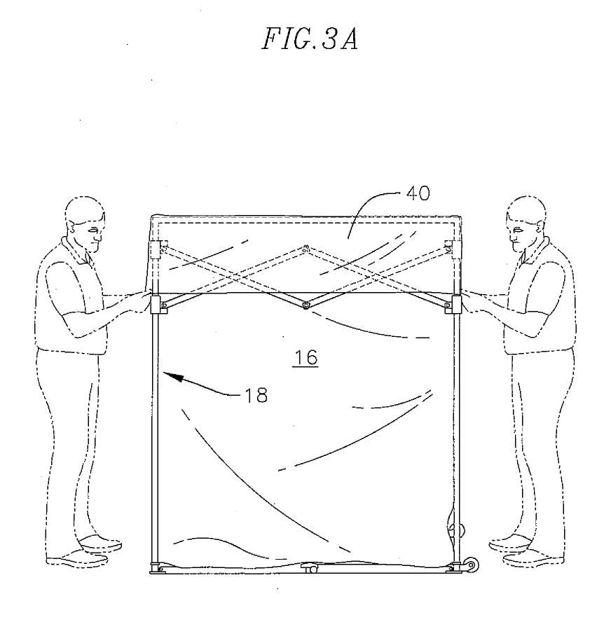

An embodiment of the frame 18 is shown in more detail in FIG. 2. The frame 18 includes four vertical legs 20, which may be telescoping legs with upper and lower members that slide relative to each other to extend the vertical height of the frame. A truss assembly 22 extends between each pair of adjacent legs 20. This truss assembly includes pivoting arms 23 that pivot relative to each other to collapse the frame for storage. Each truss assembly is connected to a slider 24 that slides along each leg when the frame is folded. The frame also includes an extension 26 above the legs 20, which extends upwardly to the ceiling to seal the working area inside the enclosure. The frame may include a base 28 such as horizontal bars or arms connecting the legs 20, for stability, and may include wheels 30 for easy transport.

Additional details regarding a suitable frame may be found in U.S. Pat. No. 7,134,444, the contents of which are expressly incorporated herein by reference.

Referring again to FIG. 1, the envelope 16 defines an inner working space 14 within the inside surface of the envelope 16. The envelope 16 includes side walls 34 and a floor 36 that are sealed together, such as by heat sealing, with an open top 38. The open top end of the envelope is folded outwardly and over the frame, creating a folded portion 40 of the envelope over a top portion 18A of the frame. The envelope is sized such that the folded portion 40 fits snugly over the top portion 18A of the frame. The side walls 34 hang down from the folded portion 40, to the floor 36, which rests on the floor of the working environment. The floor 36 may included a padded and/or non-slip or anti-scoot texture on the inside and/or outside surface of the floor 36. In one embodiment, the inside surface of the floor has a sticky or tacky texture, or an integrated or separable tacky mat, to provide a cushioned and non-slip work surface. Because the envelope is disposable, a sticky surface can be provided inside the envelope. In envelopes or barriers that are used multiple times and decontaminated between uses, an integrated sticky or tacky surface or mat is not practical, as it is very difficult to clean.

In the figures, the envelope 16 includes an open top, for access to a ceiling. However, in other embodiments, the envelope may have a closed or closable top. For example, a ceiling flap may extend over the top of the envelope and may be sealed by a zipper. The ceiling flap can be made out of the same material as the rest of the envelope. In other embodiments, the envelope may be closed on the top without any zipper access or openings.

In the embodiment shown in FIG. 1, the frame remains external of the inner working space inside the envelope. In such embodiments, the frame is not exposed to contamination within the working space, and does not need to be cleaned and de-contaminated between uses. However, in other embodiments, the frame may be located inside of the envelope. For example, the envelope may be wrapped around the outside periphery of the frame. In such a case, the frame should be de-contaminated after each use.

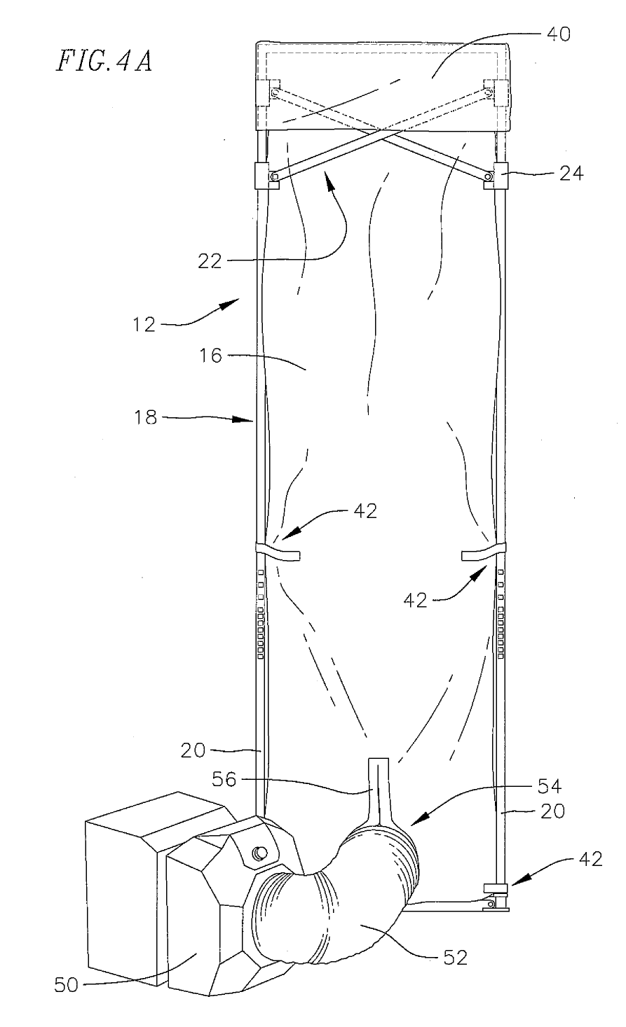

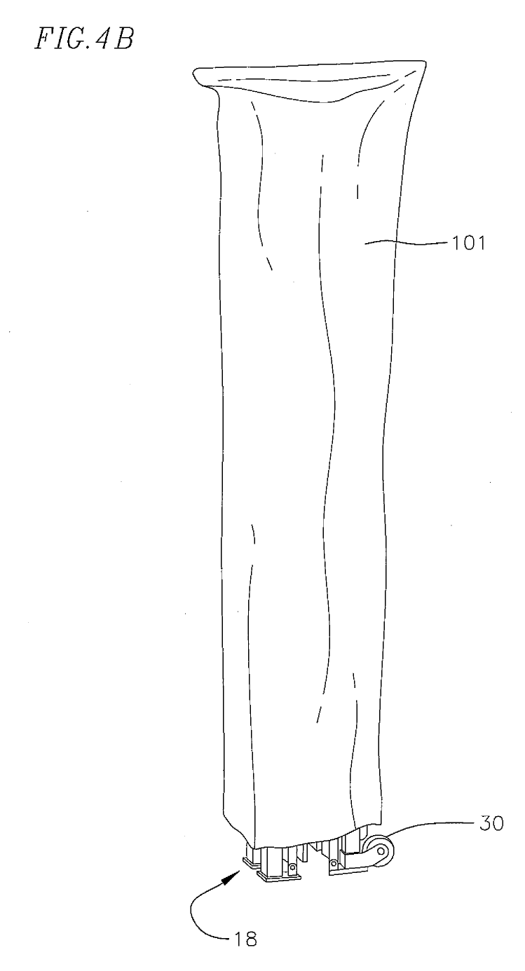

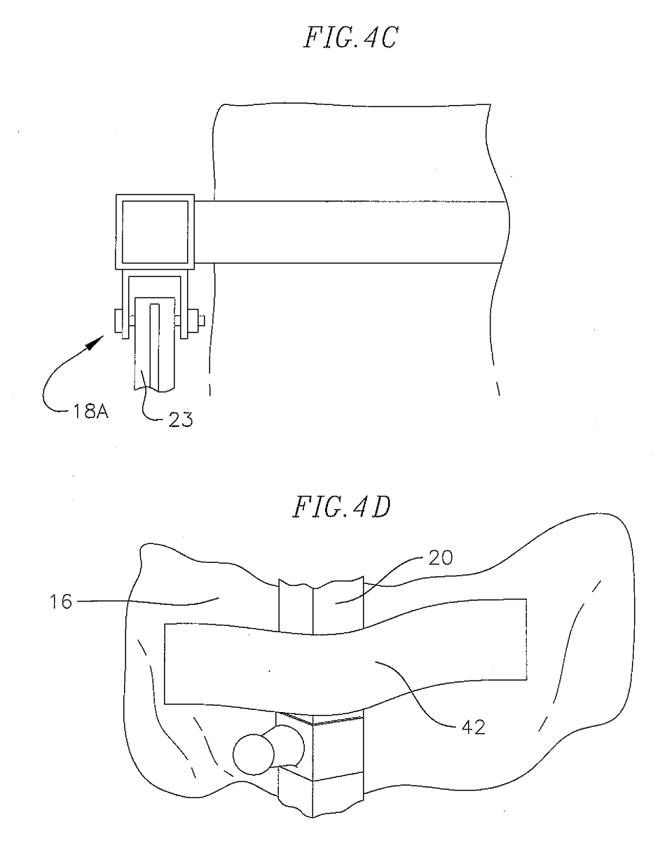

The envelope 16 is made from a lightweight plastic material that is disposable after each use. Due to its light weight, it is easily attachable to the frame 18, and requires fewer attachment points to the frame. The envelope 16 hangs from the frame 18 at the folded portion 40, and in an exemplary embodiment is secured to each leg 20 of the frame. In the embodiment shown, the envelope is secured to each leg 20 by a fastener 42. The fastener extends from the envelope 16, externally around the leg 20, and secures again to the envelope. In one embodiment, the fastener is a plastic or cloth strip with two opposite ends. One end is permanently attached to the envelope, such as by an adhesive, and the other opposite end is removably attachable to the envelope, such as by hook and loop fasteners or snaps. In this way, the free end of the fastener 42 can be looped around the leg 20 and then secured to the envelope. The envelope may include a corresponding area of hook and loop fastener material to receive the free end of the fastener. In other embodiments, the fastener may be removable from the envelope at both ends, such as by using hook and look fasteners or snaps at both ends, or an opening on one end that receives a projection, such as a button. Other types of fasteners may also be used. Where the frame 18 includes four legs 20, the envelope may be provided with four fasteners 42 about mid-way along the height of the envelope (see FIG. 1), or eight fasteners 42, mid-way and at the bottom of the envelope (see FIG. 4A). Optionally, another set of four fasteners can be provided toward the top of the envelope, to loop around the legs at the top of the frame, or to secure the folded portion 40 to the envelope 16. In addition to plastic or fabric strips, the fasteners may be formed as elastic bands, cables, or any other suitable fastener.

The fasteners 42 secure the envelope to the legs 20 to provide an open interior working space 14, and to securely support the envelope on the frame. Due to the light weight of the material of the envelope, the envelope can be supported on the frame 40 with as few as four or eight fasteners, one or two per leg, and the folded portion 40 snugly extending over the top of the frame.

Additionally, in one embodiment, the fasteners 42 are secured to the envelope 16 at both ends of the fastener, rather than being secured directly to the frame. The fastener loops around the frame and attaches back to the envelope. As a result, the frame itself does not require any particular attachment mechanisms for receiving or securing the envelope. The envelope and the fasteners can be secured anywhere along the length of the legs 20. The legs 20 may be free of snaps, hook and loop fasteners, glue, or other attachment mechanisms, and as a result the legs are easier to clean, telescope up and down, and maneuver. No residue is left on the legs after use. Moreover, the envelope 16 can be hung and secured to the frame without any positive attachment features on the frame itself. The open top of the envelope is simply folded over the top of the frame, and the fasteners of the envelope are secured to the envelope itself. The envelope is thus supported by the frame, without requiring any affirmative mechanical attachment provided by the frame itself. Also, the envelope 16 can be mounted to the frame 18 without any external attachment pieces, such as external, separate clips, screws, or bands. The fasteners 42 are provided on the envelope to loop around the legs, and the folded portion 40 is a portion of the envelope itself. Thus, in exemplary embodiments, no external tools or attachment mechanisms are needed to mount the envelope onto the frame. In another embodiment, the legs 20 may include a fastener for the envelope, such as a projection for hanging or tying the envelope to the frame or for being received in an opening in a projection of the envelope. In another embodiment, the envelope may include a fastener for engaging a complementary fastener or opening in the frame.

In another embodiment, the envelope may be fastened directly to the frame itself. For example, instead of passing the fasteners 42 around the legs 20, the fasteners may attach directly to the legs. In such an embodiment, the legs 20 can be provided with a hook and loop fastener, or button, or other attachment mechanism that attaches to the free end of the fastener 42.

In an embodiment, the envelope 16 is provided with an opening 44 on one side, for entry by a worker into the inner working space 14. In the embodiment shown, the opening 44 is a vertical slit sealed by a zipper 46. This zipper can be opened or closed to provide access to the inner space 14 as necessary. In one embodiment, the zipper is a heavy-duty fabric zipper, about 84 inches in length. The zipper shown in the figures is a vertical slit, but in other embodiments the zipper may be provided in other orientations (such as horizontal) or other shapes (such as curved, or C-shaped). A curved zipper may be useful to provide wider access when the zipper is opened. Additionally, instead of a zipper, the slit or opening can be sealed with mating hook and loop fasteners.

In an embodiment, the envelope 16 also includes a pouch 48 for the display of appropriate work permits. Although not shown, the envelope may also be provided with windows for viewing into and out of the inner work space 14. Additionally, the envelope may be provided with a time-indicator that indicates the duration of time that the envelope has been in use. For example, in one embodiment, the time-indicator is an oxidizing sticker on an outside surface of the wall 34. When the envelope is installed, a film on the sticker is removed so that the sticker is exposed to the surrounding air. Over time, the sticker oxidizes with this exposure to the air, and the sticker changes color. The color of the sticker can thus indicate how long the envelope has been in use. After a selected amount of time has passed, the envelope is discarded. In other embodiments, other suitable time-indicators may be used.

While one opening 44 is shown in FIG. 1, the envelope may be provided with additional entries or access points on one or more sides of the envelope. A shorter zipper may be provided on one side of the envelope for access to a wall. A second door may be provided opposite the first, so that the envelope can be used as an anteroom or airlock. Zippers and openings can be provided in various combinations and configurations on the envelope.

In one embodiment, the envelope 16 may is provided with an external flange around one or more sides of the envelope, to couple the envelope to another structure. For example, as shown in FIGS. 6A and 6B, a flange 60 can be attached to any side of the envelope 16 to extend the envelope to a door, such as the door of a patient room. In this arrangement, the envelope 16 can act as an anteroom or airlock. A flange can also be provided around the top end of the envelope, extending between the envelope and the ceiling, to widen the area of ceiling accessible within the enclosure. A flange around the envelope can be used to seal a corridor, to isolate a particular area. The flange can be an extruded portion of the envelope that extends past the enclosure 12, or it can be an extra piece that is attached to the envelope such as by zippers or hook and loop fasteners. The flange may be made of the same material as the envelope. Additionally, the envelope may be part of a larger modular system, with different pieces that attach to each other to create desired shapes and configurations.

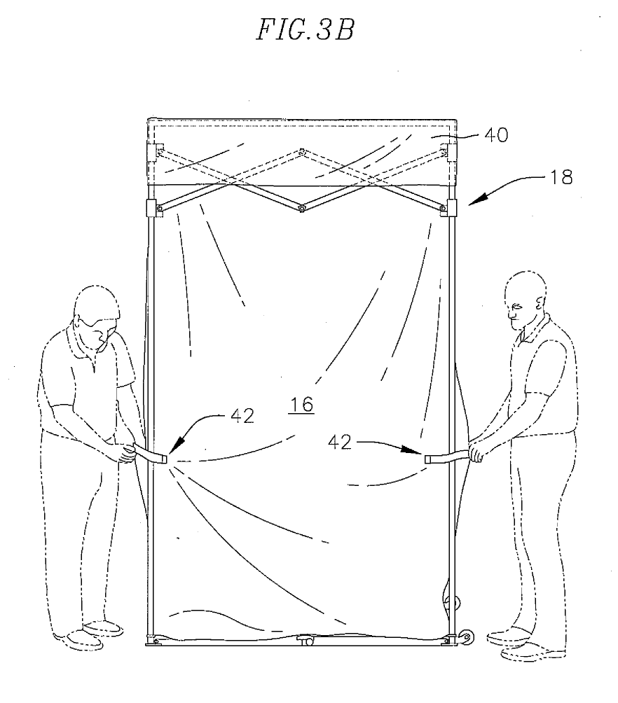

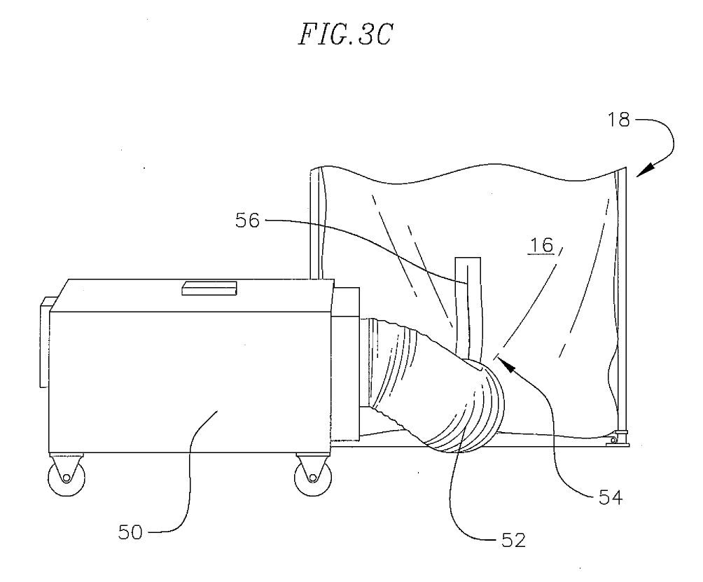

In use, a negative air machine may be coupled to the enclosure so that any contaminants, pathogens, and particles within the enclosure are captured. For example, as shown in FIGS. 3 and 4, a negative air machine 50 includes a duct 52 that is routed to the enclosure 12. The envelope 16 includes a lower opening 54 for receiving the duct 52 into the inner working space 14. In one embodiment, the opening 54 is a vertical slit sealed by a linear zipper 56. In an embodiment, the zipper is a heavy-duty fabric zipper about 20 inches in length. The zipper seals the slit when a duct is not in use, and opens the slit for the duct when desired. The zipper can be opened the amount necessary to receive the duct, depending on the size of the duct. The linear zipper is long enough so that the slit can be opened and spread apart to receive the duct. The linear zipper is easy to operate and can accommodate multiple duct sizes, without requiring multiple openings of different sizes. The negative air machine may include a HEPA (high efficiency particulate air) filter to complete the capture and isolation of the particles within the enclosure. To meet the requirements of the Centers for Disease Control and Prevention, the negative air machine should provide 12 air changes per hour, or a pressure differential of 2 Pascals, depending on the application.

According to an embodiment of the invention, the material for the envelope 16 is selected to be a lightweight, disposable plastic material, configured to be used a single time and then disposed. The material is a fire-retardant, light-penetrating, and gas-impermeable material. In one embodiment, the material is fire retardant to NFPA 701-04 test 1, and satisfies the air permeability ASTM D 737-04 standard. An example is a polyethylene film with a thickness of about 3 mm. Because the material is thin, it is lightweight and inexpensive. The lightweight material can be quickly and easily installed on the frame, and is securely supported by the frame during use. The lightweight material also enables the containment unit to be easily transported and stored. In one embodiment, the envelope 16 weighs about 3 pounds. The envelope and frame are easy to move around and reposition as necessary.

Notably, the material can be used a single time and then discarded, thereby avoiding the effort and expense of decontaminating a used envelope for re-use. Depending on the working environment, the inside surface of the envelope 16 can become contaminated and can be difficult to clean. This inside surface may be exposed to dust particles, pathogens, or other work substances, such as caulking materials. The inside surface of the envelope exposed to these materials may be difficult to adequately clean. With the disposable envelope provided herein, no cleaning is necessary. The disposable envelope can therefore be used in situations where de-contamination is prohibitively expensive or not possible, such as work environments involving exposure to asbestos or lead. Additionally, if the envelope is damaged during use, the envelope can simply be discarded rather than repaired. The disposable envelope provides important risk mitigation, by providing a clean envelope for each work scenario. There is no concern regarding whether the envelope has been properly de-contaminated after its prior use, or whether it has been damaged or properly repaired. These risks are avoided by providing a new envelope and discarding the used ones.

While the envelope is described herein as single use, or one-time use, a single use of the envelope may last for more than one day, and may include use of the envelope at multiple locations. For example, an envelope may be installed below a ceiling tile for access to the ceiling, and after the work is completed, the enclosure can be wheeled across a portion of the facility to a second ceiling tile, for a second work assignment. Thus, multiple ceiling penetrations may be accomplished with a single use of the envelope. After such use, the envelope is discarded. If the envelope becomes degraded or damaged during the use, it should also be discarded and a new envelope installed. Because the envelopes are intended to be disposable, the envelope does not need to be cleaned or repaired between ceiling penetrations or during use, as a new envelope can be installed in its place. A single use, or one-time use, of the envelope is intended to encompass use of the envelope in one or more locations without cleaning, decontamination, or repairs.

In one embodiment, the envelope is formed as a seamless tube with an attached floor and an open top. That is, the side wall 34 of the envelope is a continuous wall. The material is blown or stretched into a long tube, and is then cut at the appropriate height. A floor is attached at one end to close the envelope, or alternatively one end of the tube is sealed together in a single seam to close the envelope. In this embodiment, the side wall 34 does not have any seams. In another embodiment, the envelope is formed as a blown bag, with an integral floor and side walls, devoid of seams. In other embodiments, the envelope can be formed by four side walls attached at four vertical seams, or other configurations and shapes. In another embodiment, the envelope can be formed by two segments of plastic folded around and joined at two seams. Other configurations of seams are possible.

A method for isolating a work area from a surrounding environment is provided according to one embodiment of the invention. Referring to FIG. 3A, the frame 18 is first opened at mid-height at the working site, such as below a ceiling tile that needs to be accessed. The envelope 16 is placed inside the frame and spread open. The top portion of the envelope is folded over the top portion of the frame. With the top portion of the envelope snugly folded over the frame, the frame is then extended to the necessary height, depending on the work environment, such as to the ceiling inside a building, as shown in FIG. 3B. The fasteners 42 are passed around each leg 20 of the frame and secured to the envelope 16. As shown in FIG. 3C, a negative air machine and filter 50 may then be communicated with the inner working space, such as through the lower opening 54.

An environmental containment unit 100 is shown in FIGS. 4A-D. FIG. 4A shows the unit in operating position, with the frame 18 extended, and a folded portion 40 of the envelope or barrier 16 folded over the top portion of the frame. A negative air machine 50 includes a duct 52 that passes through an opening 54 in the envelope. The opening 54 is sealed by a zipper 56. FIG. 4B shows the unit 100 in transport position, before use. The unit can be easily transported to the desired work area, on wheels 30 at the bottom of the frame 18. FIG. 4C shows an enlarged view of the top portion 18A of the frame, before the envelope has been folded over. FIG. 4D shows an enlarged view of a fastener 42, passing around a leg 20 of the frame 18.

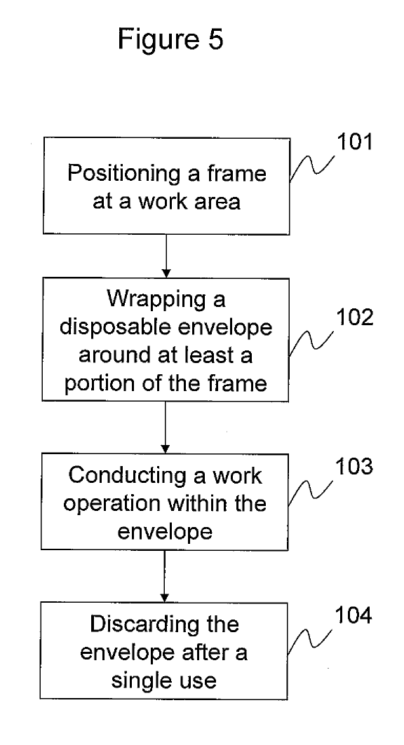

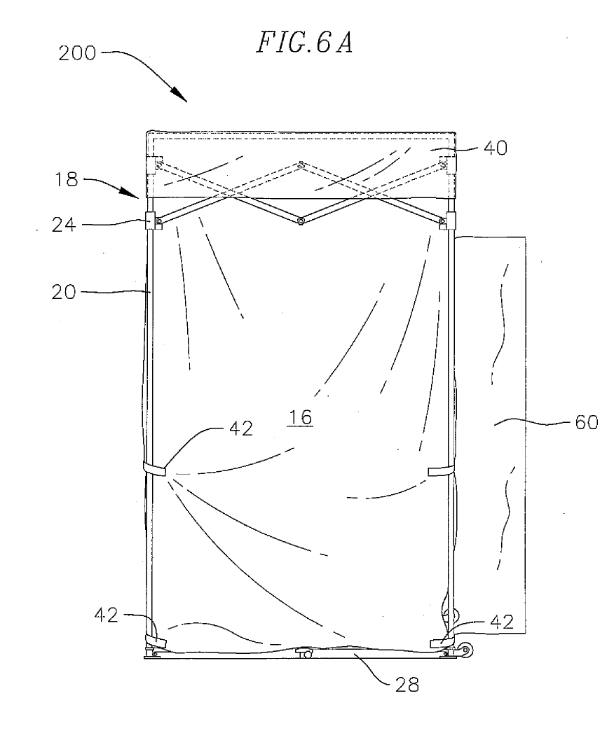

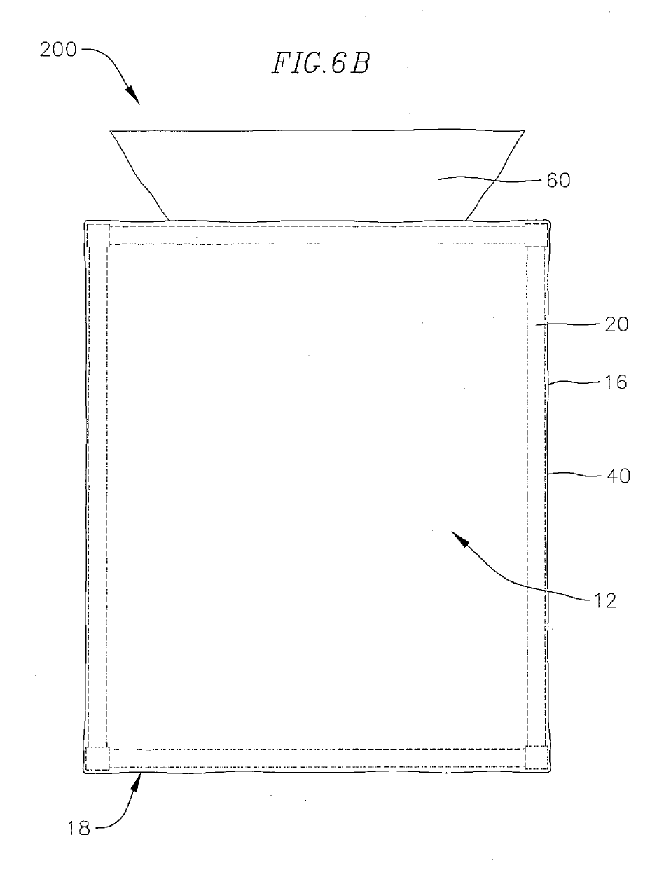

FIG. 5 shows a method for isolating a work area from a surrounding environment, according to an embodiment. The method includes positioning a frame at the work area (101). This may include positioning the frame below a ceiling tile, or other area where work is to be performed. If an extendable frame is used, the method may also include extending the frame to the desired configuration, such as upwardly to the ceiling. The method also includes wrapping a disposable envelope around at least a portion of the frame (102). This may include folding a portion of the envelope outwardly over a top portion of the frame. The method also includes conducting a work operation within the envelope (103), and discarding the envelope after a single use (104). In various embodiments, the method may also include connecting the envelope to a second structure and utilizing the envelope as an airlock for entry into the second structure, as described in further detail above.

The environmental containment unit 10 can remain in place for the duration of the work, which may be, for example, from a few hours up to 5 days, or more. The open top of the enclosure provides access to the ceiling above the enclosure. When the work is completed, the negative air machine and ducting are removed, the lower opening 54 is sealed, and the envelope 16 is unfastened from the frame 18. The open top of the envelope can be cinched (such as with a zip or cable tie) to seal any contaminants inside, as shown in FIG. 2. In one embodiment, the envelope is provided with an integrated pull-tie 58 around the top portion of the envelope, for sealing the envelope after use. The entire envelope can then be safely discarded. With the top cinched, the envelope can act as its own bag for disposal. In addition, the original packaging used to ship the bag may be used as a second outer bag to wrap the used envelope for discarding. The envelope can be discarded according to standard procedures for discarding contaminated material. The frame may be folded and stored, or repositioned for another job.

Because the envelope and frame are easy to position and install, and the envelope is easy to use and discard, the environmental containment unit can be used in many different applications throughout a facility, providing a standard procedure and apparatus for isolating a work space. The environmental containment unit can be easily recognized, and workers can follow consistent procedures, to enhance the overall effectiveness of the unit.

Although the present invention has been described and illustrated in respect to exemplary embodiments, it is to be understood that it is not to be so limited, since changes and modifications may be made therein which are within the full intended scope of this invention as hereinafter claimed.

What is claimed is:

1. An environmental containment unit comprising:
a frame; and
a disposable barrier supported by the frame,
wherein a portion of the barrier is folded outwardly over the frame, and
wherein the barrier comprises polyethylene and is disposable after a single use.

2. The environmental containment unit of claim 1, wherein the barrier wraps around a top portion of the frame, and wherein a first portion of the barrier passes around the frame and removably attaches to a second portion of the barrier to retain the barrier on the frame.

3. The environmental containment unit of claim 1, wherein the barrier comprises a tube and a floor, and wherein the tube comprises a polyethylene film devoid of seams

4. An environmental containment unit comprising:
an extendable frame comprising a top portion and first and second legs;
a disposable envelope comprising a wall and a floor, wherein the envelope is folded over the top portion of the frame; and
a fastener passed around the first or second leg and fastened to the envelope, to retain the envelope to the frame.

5. The environmental containment unit of claim 4, wherein the wall of the envelope comprises a continuous tube, and wherein the tube is sealed by the floor.

6. The environmental containment unit of claim 4, wherein a first end of the fastener is attached to the envelope, and a second opposite end of the fastener is passed around the respective leg and removably attached to the envelope.

7. The environmental containment unit of claim 4, wherein the envelope comprises a side access opening.

8. The environmental containment unit of claim 7, wherein the side access opening comprises a curved slit.

9. The environmental containment unit of claim 4, further comprising a flange attachable to the envelope for extending between the envelope and a second structure.

10. The environmental containment unit of claim 9, wherein the envelope provides an airlock for entry into the second structure.

11. The environmental containment unit of claim 4, further comprising a time indicator measuring a duration of use of the envelope.

12. The environmental containment unit of claim 11, wherein the time indicator comprises an oxidizing sticker.

13. The environmental containment unit of claim 4, wherein the floor comprises an integrated floor mat having a sticky or tacky texture.

14. The environmental containment unit of claim 4, wherein the envelope comprises an opening for receiving a duct for a negative air machine or filter.

15. The environmental containment unit of claim 4, wherein the envelope comprises an integrated pull-tie.

16. The environmental containment unit of claim 4, wherein the envelope comprises a fire-retardant, light-penetrating, and gas-impermeable material configured for a single use.

17. The environmental containment unit of claim 4, wherein the envelope comprises polyethylene film.

18. A method for isolating a work area from a surrounding environment, comprising:
positioning a frame at the work area;
wrapping a disposable envelope around at least a portion of the frame;
conducting a work operation within the envelope; and
discarding the envelope after a single use.

19. The method of claim 18, further comprising connecting the envelope to a second structure and utilizing the envelope as an airlock for entry into the second structure.

20. The method of claim 18, wherein the envelope comprises a tube and a floor, and wherein the tube comprises a polyethylene film devoid of seams.

21. The method of claim 18, further comprising extending the frame to a desired configuration.
